(19) United States
(12) Patent Application Publication
(10) Pub. No.: US 2025/0172784 A1
(43) Pub. Date: May 29, 2025

(54) VIBRATION-TYPE ACTUATOR, OPTICAL APPARATUS, AND ELECTRONIC APPARATUS

(71) Applicant: CANON KABUSHIKI KAISHA, Tokyo (JP)

(72) Inventors: YASUYUKI ARAKI, Tokyo (JP); NOBUYUKI KOJIMA, Tokyo (JP); KEI SUEFUJI, Tokyo (JP)

(21) Appl. No.: 18/954,211

(22) Filed: Nov. 20, 2024

(30) Foreign Application Priority Data
Nov. 29, 2023 (JP) 2023-201981

(51) Int. Cl. G02B 7/08

(52) U.S. Cl. CPC G02B 7/08

(57) ABSTRACT

A vibration-type actuator includes a vibration damping member extending in the first direction and configured to be in contact with a surface of a contact body on an opposite side of another surface of the contact body in contact with a vibrating body, and a support member extending in the first direction and configured to support the contact body via the vibration damping member, wherein a support member includes a convex portion on a surface of the support member in contact with the vibration damping member, and the convex portion extends in the first direction and is in contact with the vibration damping member, and wherein, in a direction orthogonal to the first direction, a width of the convex portion is smaller than a width of the contact body and a width of the vibration damping member.

### BACKGROUND

### Field

The present disclosure relates to a vibration-type actuator, an optical apparatus, and an electronic apparatus.

### Description of the Related Art

There is known a vibration-type actuator in which a vibrating body using an electro-mechanical energy conversion element and a contact body are brought into contact with each other by pressure, the vibrating body is excited to generate predetermined vibration, and frictional drive force is applied by the vibrating body to the contact body, whereby the vibrating body and the contact body are relatively moved.

Japanese Patent Application Laid-Open No. 2021-2923 discusses a vibration-type actuator including a vibration damping member interposed and held in contact between a contact portion and a guide member for the purpose of reducing undesired vibration, which is vibration in an audible range and causes abnormal noise.

With a configuration discussed in Japanese Patent Application Laid-Open No. 2021-2923, there are cases where the vibration damping member is misaligned due to variations in assembling, and a region in which the vibration damping member is in contact with the contact body becomes asymmetrical. Additionally, in a case where butyl rubber or the like is used as the vibration damping member and the vibration damping member is manufactured by cutting a rubber sheet in a desired shape, variations in dimension increase. As a result, a contact area of the vibration damping member in contact with the contact body changes depending on a lot, and variations in performance are likely to occur.

### SUMMARY

The present disclosure is directed to provision of a vibration-type actuator in which generation of undesired vibration is reduced and variations in vibration damping properties between lots are reduced. Additionally, the present disclosure is directed to provision of an optical apparatus or an electronic apparatus including the vibration-type actuator in which generation of undesired vibration is reduced and variations in vibration damping properties between lots are reduced.

According to some embodiments, a vibration-type actuator that includes a vibrating body including an electro-mechanical energy conversion element and an elastic body, and a contact body configured to be in contact with the elastic body and extending in a first direction, and is configured to cause the vibrating body to vibrate so as to cause the vibrating body and the contact body to relatively move in the first direction. The vibration-type actuator further includes a vibration damping member extending in the first direction and configured to be in contact with a surface of the contact body on an opposite side of another surface of the contact body in contact with the vibrating body, and a support member extending in the first direction and configured to support the contact body via the vibration damping member. The support member includes a convex portion on a surface of the support member in contact with the vibration damping member, and the convex portion extends in the first direction and is in contact with the vibration damping member. In a direction orthogonal to the first direction, a width of the convex portion is smaller than a width of the contact body and a width of the vibration damping member.

According to another aspect of the present disclosure, an optical apparatus or an electric apparatus may include a vibration-type actuator that includes a vibrating body including an electro-mechanical energy conversion element and an elastic body, and a contact body configured to be in contact with the elastic body and extending in a first direction, and is configured to cause the vibrating body to vibrate so as to cause the vibrating body and the contact body to relatively move in the first direction. The vibration-type actuator included in the optical apparatus or the electric apparatus further includes a vibration damping member extending in the first direction and configured to be in contact with a surface of the contact body on an opposite side of another surface of the contact body in contact with the vibrating body, and a support member extending in the first direction and configured to support the contact body via the vibration damping member. The support member includes a convex portion on a surface of the support member in contact with the vibration damping member, and the convex portion extends in the first direction and is in contact with the vibration damping member. In a direction orthogonal to the first direction, a width of the convex portion is smaller than a width of the contact body and a width of the vibration damping member.

Further features of the present disclosure will become apparent from the following description of exemplary embodiments with reference to the attached drawings.

### BRIEF DESCRIPTION OF THE DRAWINGS

FIGS. 1A to 1C are schematic views each illustrating a vibration-type actuator according to a first exemplary embodiment.

FIGS. 2A and 2B are schematic views each illustrating a vibrating body of the vibration-type actuator according to the first exemplary embodiment.

FIG. 3 is a schematic view illustrating an example of arrangement of a vibration damping member according to the first exemplary embodiment.

FIG. 4 is a schematic view illustrating an example of a vibration damping member according to a second exemplary embodiment.

FIGS. 5A and 5B are schematic views each illustrating an example of the vibration damping member according to the second exemplary embodiment.

FIGS. 6A and 6B are schematic views each illustrating an example of the vibration damping member according to the second exemplary embodiment.

FIG. 7 is a schematic view each illustrating a configuration of an imaging apparatus according to a third exemplary embodiment.

FIG. 8 is a schematic view illustrating an example of a configuration of a robot according to a fourth exemplary embodiment.

### DESCRIPTION OF THE EMBODIMENTS

As described above, with a configuration discussed in Japanese Patent Application Laid-Open No. 2021-2923, there are cases where the vibration damping member is misaligned due to variations in assembling, and a region in which the vibration damping member is in contact with the contact body becomes asymmetrical. Additionally, in a case where butyl rubber or the like is used as the vibration damping member and the vibration damping member is manufactured by cutting a rubber sheet in a desired shape, variations in dimension increase. As a result, a contact area of the vibration damping member in contact with the contact body changes depending on a lot, and variations in performance are likely to occur.

In order to reduce generation of abnormal noise (sound in an audible range) at the time of driving of the vibration-type actuator, the inventors of the present disclosure have examined a configuration of reducing generation of undesired vibration (vibration unnecessary for driving) of the vibration-type actuator. As a result, it has been found that, in a case where an area of the vibration damping member interposed and held in contact between the contact body and a support member is reduced due to variations in assembling, abnormal noise is likely to be generated.

In addressing this issue, the inventors of the present disclosure have found that providing a convex portion on a surface of the support member that is to be in contact with the vibration damping member can bring the vibration damping member into contact with the contact body in a region with a constant area regardless of variations in assembling. Additionally, the inventors of the present disclosure have found that, instead of providing the convex portion in the support member, providing a groove portion or a penetrating portion in the vibration damping member can bring the vibration damping member into contact with the contact body in a region with a substantially constant area regardless of variations in assembling. Bringing the vibration damping member into contact with the contact body in the region with a substantially constant area can reduce generation of abnormal noise at the time of driving of the vibration-type actuator.

The inventors of the present disclosure have examined use of butyl rubber, which is excellent especially in vibration damping properties, as the vibration damping member. As a result, it has been found that, since large elastic reactive force is applied to the contact body in a state where the vibration damping member is pressed hard, flexure of the contact body may be increased. The increase in the flexure of the contact body increases a distance between hooks of tension springs that generate pressure force for bringing the vibrating body into contact with the contact body. Hence, there may be cases where the pressure force is increased, and thus, power consumption for driving increases. The inventors of the present disclosure have found that, even in such a case, the configuration of providing the convex portion on the surface of the support member that is to be in contact with the vibration damping member and the configuration of providing the groove portion or the penetrating portion in the vibration damping member r can reduce the flexure of the contact body.

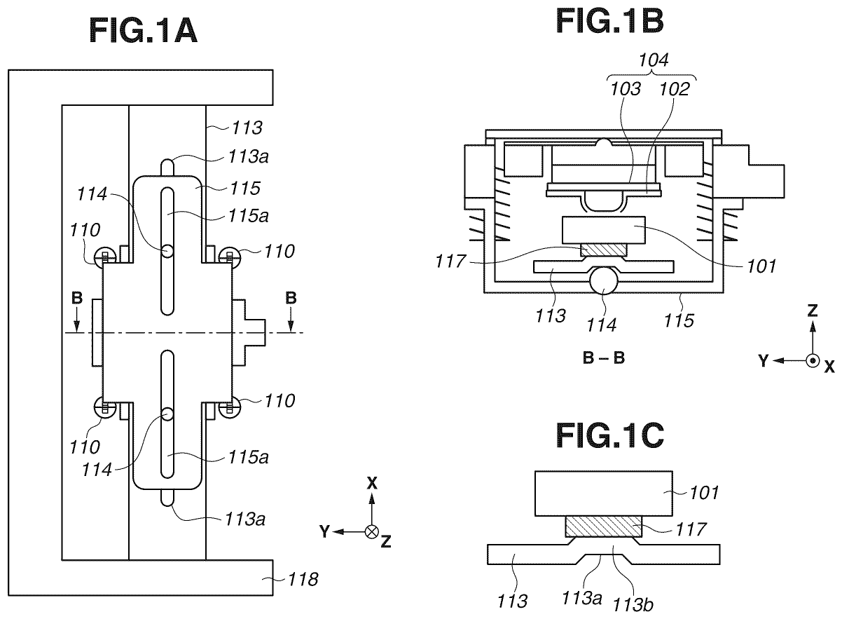

Various exemplary embodiments, features, and aspects of the present disclosure will be described below in detail with reference to the drawings. FIGS. 1A to 1C are schematic views each illustrating a configuration of a vibration-type actuator according to a first exemplary embodiment. Here, a direction in which a vibrating body 104 and a contact body 101 relatively move is defined as an X-direction (first direction), a pressure direction is defined as a Z-direction, and a direction perpendicular to the X-direction and the Z-direction is defined as a Y-direction. The pressure direction is a direction in which pressure is applied by the vibrating body 104 to the contact body 101.

FIG. 1A is a view illustrating the vibration-type actuator when viewed in a Z-axis direction. FIG. 1B is a cross-sectional view illustrating the vibration-type actuator along a B-B line illustrated in FIG. 1A. FIG. 1C is an enlarged view of a non-driven unit in FIG. 1B.

As illustrated in FIG. 1B, the vibration-type actuator includes the vibrating body 104 and the contact body 101 that is to be in contact with the vibrating body 104. The vibrating body 104 has a rectangular shape. The vibrating body 104 includes an elastic body 102 having a flat-plate shape, a piezoelectric element 103 that serves as an electro-mechanical energy conversion element bonded to one surface of the elastic body 102, and two protruding portions provided on the other surface of the elastic body 102.

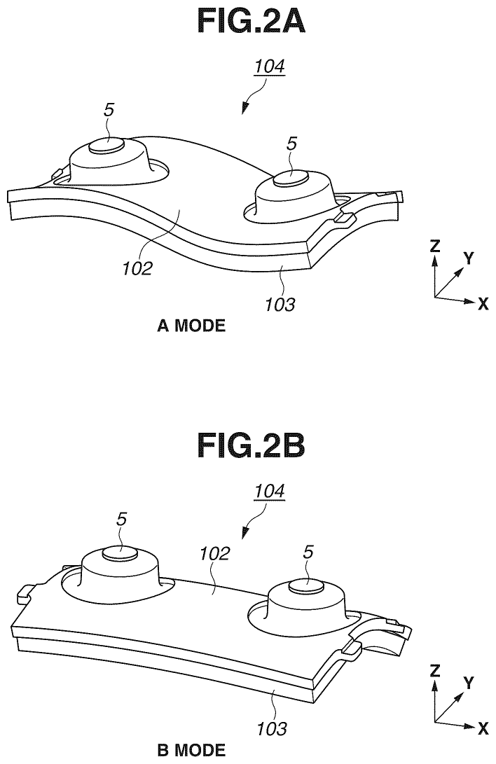

FIG. 2A is a view for describing a first vibration mode (hereinafter referred to as an “A mode”) of two bending vibration modes in which the vibrating body 104 is excited to vibrate. A common electrode (whole surface electrode) is formed on a surface of the piezoelectric element 103 on which the elastic body 102 is provided, and a driving electrode, which is divided into equal halves in a length direction, is formed on another surface of the piezoelectric element 103 that is opposite of the surface on which the elastic body 102 is provided. The common electrode and the driving electrode are not illustrated.

In the A mode, secondary bending vibration in a longitudinal direction (X-direction) of the vibrating body 104 is generated, and three nodal lines that are substantially parallel to a short-side direction (Y-direction (width direction)) of the vibrating body 104 are included. An alternating voltage at a predetermined frequency with a phase shift of 180 is applied to the driving electrode of the piezoelectric element 103, and thus it is possible to excite the vibrating body 104 to generate vibration in the A mode. Protruding portions 5 are disposed in the vicinity of a position that serves as a node of vibration in the A mode, and the vibrating body 104 is excited to generate vibration in the A mode, whereby the protruding portions 5 move reciprocally in the X-direction.

FIG. 2B is a view for describing a second vibration mode (hereinafter referred to as a “B mode”) of the two bending vibration modes in which the vibrating body 104 is excited to vibrate. In the B mode, primary bending vibration in the short-side direction (Y-direction) of the vibrating body 104 is generated, and two nodal lines that are substantially parallel to the longitudinal direction (X-direction) are included. An alternating voltage at a predetermined frequency with an identical phase is applied to the driving electrode of the piezoelectric element 103, and thus it is possible to excite the vibrating body 104 to generate vibration in the B mode. The protruding portions 5 are disposed in the vicinity of a position that serves as an antinode of vibration in the B mode, and vibration in the B mode is excited in the vibrating body 104, whereby the protruding portions 5 move reciprocally in an axis direction (Z-direction) of the protruding portions 5.

The vibrating body 104 is configured so that the nodal lines in the A mode and the nodal lines in the B mode are substantially orthogonal to each other in an X-Y plane. A flexible substrate (not illustrated) is bonded to the piezoelectric element 103 and alternating-current is supplied to the piezoelectric element 103 through the flexible substrate, whereby it is possible to excite the vibrating body 104 to generate vibration in the A mode and vibration in the B mode simultaneously. Hence, exciting the vibrating body 104 to generate vibration in the A mode and vibration in the B mode with a predetermined phase difference can generate elliptic motion at leading ends of the protruding portions 5 within a Z-X plane.

In the vibration-type actuator, the vibrating body 104 is in contact with the contact body 101. Hence, by exciting the vibrating body 104 to generate vibration in the A mode and vibration in the B mode simultaneously, elliptic motion that is generated at the leading ends of the two protrusions causes the vibrating body 104 to move relative to the contact body 101.

In the following description, a direction in which the vibrating body 104 and the contact body 101 move relatively to each other (first direction) is referred to as a driving direction.

As illustrated in FIG. 1A, springs 110, which are tension springs, are disposed at four positions around the vibrating body 104 and generate pressure force by which the vibrating body 104 and the contact body 101 are brought into pressure contact with each other.

The vibration-type actuator may not have the configuration using the four springs 110 to apply the pressure force, and a type of the spring is not limited to a tension spring. In the following description, a direction in which the pressure force is applied to bring the vibrating body 104 and the contact body 101 into pressure contact with each other is referred to as a pressure direction, and is indicated as the Z-axis direction in the drawings.

A movable side guide member 115 includes two movable side rolling grooves 115a each having a substantially V-shape. In the movable side rolling grooves 115a, respective rolling balls 114 are disposed. The movable side guide member 115 also includes hook portions for fixing the springs 110. Meanwhile, a fixed side guide member 113 that serves as a support member and supports the contact body 101 via a vibration damping member 117 includes fixed side rolling grooves 113a each having a substantially trapezoid shape. The rolling balls 114 are interposed between the fixed side rolling grooves 113a included in the fixed side guide member 113 and the movable side rolling grooves 115a included in the movable side guide member 115. A guide mechanism, which includes the fixed side rolling grooves 113a, the rolling balls 114, and the movable side rolling grooves 115a, allows the vibrating body 104 to move relative to the contact body 101.

Configurations of the contact body 101, the vibration damping member 117, the fixed side guide member (support member) 113, and a fixing frame member 118 are now described. The contact body 101 is, together with the fixed side guide member (support member) 113 that guides the relative movement of the vibrating body 104 and the contact body 101, fixed to a fixing frame member 118 at both end portions thereof in the driving direction with screws or the like. The screws are not illustrated.

In the support member 113, which serves as a fixed side guide unit and supports the contact body 101 via the vibration damping member 117, a convex portion 113b extending in the X-axis direction is formed. That is, the convex portion 113b has a rectangular shape when viewed from the above (a +Z-axis direction), and a longitudinal direction thereof is the X-axis direction.

The convex portion 113b is provided at a position overlapping with a protruding portion of the contact body 101 in the Z-axis direction. The convex portion 113b is formed by press work. The fixed side rolling grooves 113a as concave portions, in which the respective rolling balls 114 roll, are formed on the opposite side of the convex portion 113b. In the present exemplary embodiment, the example in which a surface of the convex portion 113b in contact with the vibration damping member 117 is a flat surface is described. However, the surface of the convex portion 113b is not limited thereto, and may be a curved surface.

The vibration damping member 117 extends in the X-axis direction similarly to the contact body 101. The vibration damping member 117 is in contact with the contact body 101 on the opposite side of the vibrating body 104, and is interposed and held in contact between the contact body 101 and the convex portion 113b of the fixed side guide member (support member) 113 in the pressure direction. A width of the convex portion 113b mentioned herein is smaller than a width of the contact body 101, and a width of the vibration damping member 117 is larger than the width of the convex portion 113b. The width of each member mentioned herein represents a length of each member in the Y-axis direction (direction orthogonal to the first direction).

A material of the vibration damping member 117 is desirably a material having excellent vibration damping properties (for example, a high vibration damping rate). Examples of the material include butyl rubber.

A distance (gap) between the contact body 101 and the convex portion 113b of the fixed side guide member 113 is smaller than the thickness of the vibration damping member 117. This distance has a value determined by dimensions of the contact body 101, the fixed side guide member 113, and the fixing frame member 118. The vibration damping member 117 has elasticity. The vibration damping member 117 is interposed and held in contact between the contact body 101 and the fixed side guide member 113, whereby urging force is generated to the contact body 101 and the fixed side guide member 113 due to elastic reaction force.

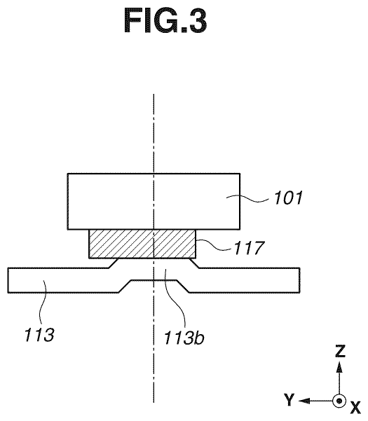

FIG. 3 is a view illustrating the arrangement of the vibration damping member 117 according to the present exemplary embodiment, and illustrates a state where the vibration damping member 117 is interposed and held in contact between the contact body 101 and the fixed side guide member 113 with its position shifted in the Y-direction at the time of assembling. The vibration damping member 117 is misaligned in a +Y-axis direction and the fixed side guide member 113 is misaligned in a −Y-axis direction when they are based on the position of the contact body 101.

The following description will be given of a reason that, even if the misalignment occurs, the influence on the vibration damping properties can be reduced in the present exemplary embodiment. The convex portion 113b is provided in the fixed side guide member 113, and the vibration damping member 117 is interposed and held in contact between the contact body 101 and the fixed side guide member 113 via the convex portion 113b. Hence, even in a case where the vibration damping member 117 is interposed and held in contact therebetween with its position shifted in the Y-direction, an area of the interposed and held portion of the vibration damping member 117 does not change.

If the contact body 101 and the fixed side guide member 113 are positioned with high accuracy, the interposed and held portion of the vibration damping member 117 can be maintained to be symmetrical with respect to a center line even if the vibration damping member 117 is positioned without strict accuracy. The interposed and held portion mentioned herein indicates not a portion in which only one surface of the vibration damping member 117 is in contact with another member, but a potion in which both surfaces of the vibration damping member 117 are interposed and held in contact between other members while being pressurized by the members.

In comparison with the other components, variations in dimension between lots are likely to occur in the vibration damping member 117 in terms of the nature of the processing method. Meanwhile, by setting the width of the vibration damping member 117 in consideration of the width of the convex portion 113b, values that may cause the misalignment, and variations in the width of the vibration damping member 117, it is possible to reduce variations in vibration damping properties between lots. The flexure of the contact body 101 is adjusted by adjustment of the width of the convex portion 113b in a range that does not cause any issue related to the vibration damping properties, and adjustment of the area of the interposed and held portion of the vibration damping member 117.

In a second exemplary embodiment, a first modification example of the vibration damping member 117 will be described. The other components including the contact body 101 and the fixed side guide member 113 are similar to those in the first exemplary embodiment, and thus a detailed description thereof is omitted.

The vibration damping member 117 has elasticity and is interposed and held in contact between the contact body 101 and the fixed side guide member 113, whereby urging force is generated to the contact body 101 and the fixed side guide member 113 due to elastic reaction force. As a result, the flexure is generated in the contact body 101 and the fixed side guide member 113. Since the shape of the fixed side guide member 113 has been devised so as to increase rigidity represented by moment of inertia of area in the present exemplary embodiment, the flexure of the fixed side guide member 113 is relatively small. In contrast, if the contact body 101 is elongated in order to extend a range that can be driven in the configuration according to the first exemplary embodiment, there may be cases where especially the flexure of the contact body 101 increases to an extent that cannot be neglected.

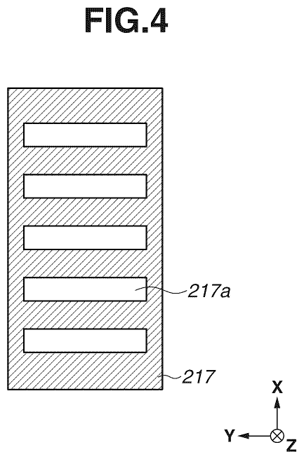

An example of the shape of the vibration damping member according to the present exemplary embodiment is described with reference to FIGS. 4, 5A, 5B, 6A, and 6B. As illustrated in FIG. 4, a vibration damping member 217 includes a plurality of penetrating portions 217a each having a rectangular shape. The penetrating portions 217a are through-holes that run the surface of the vibration damping member 217 in contact with the contact body 101 to the surface of the vibration damping member 217 in contact with the fixed side guide member 113. A short-side direction of the penetrating portions 217a coincides with the X-direction, and a longitudinal direction of the penetrating portions 217a coincides with the Y-direction. A width of each penetrating portion 217a in the longitudinal direction is larger than a width of the convex portion 113b of the fixed side guide member 113. The width of each member mentioned herein represents a length of each member in the Y-axis direction (direction orthogonal to the first direction).

Each penetrating portion 217a is provided at a position facing a node portion of out-of-plane bending vibration that is generated in the contact body 101 due to resonance of the contact body 101. Since it is most likely that out-of-plane vibration, of undesired vibration of the contact body 101, is generated, the vibration damping member 217 is configured to come in contact with the positions of antinodes of out-of-plane vibration, which is desired to be reduced, whereby a contact area of the vibration damping member 217 is reduced. As a result, it is effective in inhibiting deterioration of the vibration damping properties.

Providing the penetrating portions 217a in the vibration damping member 217 can reduce the area of the vibration damping member 217 interposed and held in contact between the contact body 101 and the fixed side guide member 113. As a result, the flexure of the contact body 101 and the fixed side guide member 113 is reduced. Additionally, with the configuration in which the penetrating portions 217a have the rectangular shape, even if the misalignment occurs in the Y-direction, the area of the interposed and held portion of the vibration damping member 217 does not change, and variations in vibration damping properties can be reduced. The penetrating portions 217a are not necessarily configured to have a linear shape, and the penetrating portions 217a may each include a gentle curve portion in consideration of performance.

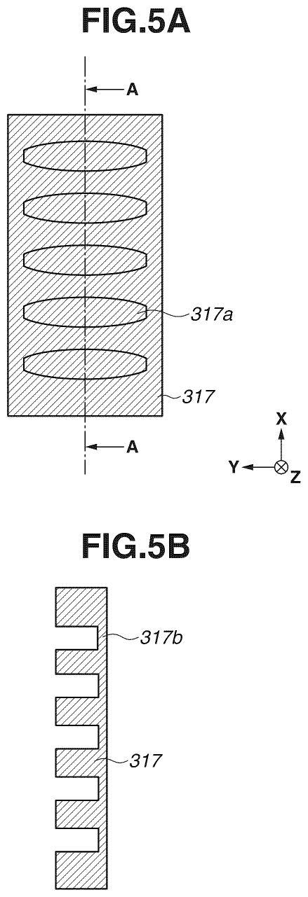

As illustrated in FIG. 5A and FIG. 5B, which is a cross-sectional view along an A-A line in FIG. 5A, a vibration damping member 317 includes a plurality of groove portions 317a each having an ellipsoidal shape. With the configuration in which the vibration damping member 317 has no penetrating portion, it is possible to produce the vibration damping member 317 in a desired shape at once at the time of rubber molding, unlike a case where the penetrating portions 217a are formed in post-processing as illustrated in FIG. 4. A magnitude of a radius (R) of a curve of each groove portion 317a is set to be a predetermined value or less depending on a permissible amount of a difference in contact area in a case where misalignment occurs.

The groove portions 317a each desirably have a large depth to reduce flexure of the contact body 101. Thin-walled portions 317b each corresponding to a difference between a whole thickness of the vibration damping member 317 and a depth of the groove portion 317a are configured to have a depth that prevents the thin-walled portions 317b from being interposed and held in contact between the contact body 101 and the fixed side guide member 113. That is, the vibration damping member 417 desirably has a shape that prevents bottom surfaces of the groove portions 317a (thin-walled portions 317b) from being in contact with the contact body 101. In the present exemplary embodiment, the depth of the groove portions 317a is set to be 60% or more of a thickness of each portion of the vibration damping member 317 where there is no groove portion 317a.

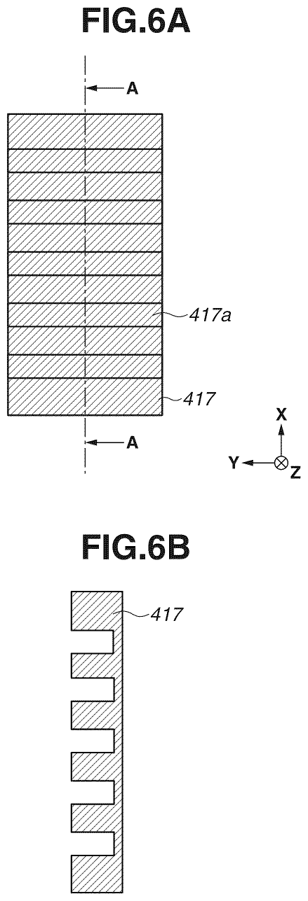

As illustrated in FIG. 6A and FIG. 6B, which is a cross-sectional view along an A-A line illustrated in FIG. 6A, a vibration damping member 417 includes a plurality of groove portions 417a each having a rectangular shape. Additionally, the vibration damping member 417 has an identical cross-sectional shape throughout its cross section in a direction parallel to the X-direction. With such a shape, it is possible to, after molding rubber into a large sheet, cut the sheet into a desirable size of the vibration damping member 417 and use the cut sheet as the vibration damping member 417, and it is possible to thereby reduce cost.

While the description has been given on the premise that the convex portion of the fixed side guide member 113 is in contact with the vibration damping member in the present exemplary embodiment, the configuration is not limited thereto and may be a configuration in which the convex portion is not provided in the fixed side guide member 113. It is desirable that a ratio of the area of the penetrating portions of the vibration damping member be adjusted and the width of the vibration damping member be larger than the width of the contact body 101. With this configuration, the whole of the contact body 101 is in pressure-contact with the vibration damping member while the flexure of the contact body 101 is permitted, whereby variations in vibration damping properties can be reduced without being influenced by misalignment.

### Application Examples of Vibration-Type Actuator

Subsequently, an imaging apparatus and an industrial robot are described as examples of a device or an apparatus to which the above-mentioned vibration-type actuator is applied.

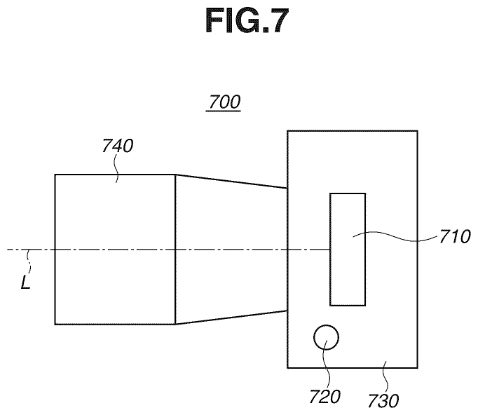

FIG. 7 is a top view illustrating a schematic configuration of an imaging apparatus 700, which is an example of an optical apparatus.

The imaging apparatus 700 includes a camera main body 730 that includes an image pickup element 710 and a power button 720. Additionally, the imaging apparatus 700 includes a lens barrel 740 that includes a lens unit and the vibration-type actuator. The lens unit is not illustrated. The lens unit, which is an example of an optical element, is driven by the vibration-type actuator. The lens barrel 740 is an interchangeable lens that is replaceable with another lens barrel. The lens barrel 740 appropriate for an imaging target can be attached to the camera main body 730. As the vibration-type actuator, the vibration-type actuator described with reference to FIGS. 2A and 2B can be used.

The use of the vibration-type actuator is considered to be suitable for driving of an autofocus lens, but is not limited thereto. It is considered that it is possible to drive a zoom lens by a similar configuration. Furthermore, the vibration-type actuator can be also used for driving of an image pickup element, and driving of a lens or an image pickup element at the time of image stabilization.

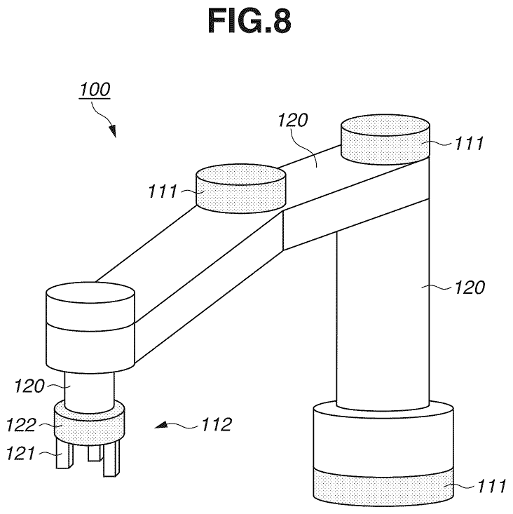

FIG. 8 is a perspective view illustrating a schematic configuration of a robot 100, which is an example of the electronic apparatus on which the vibration-type actuator described above is mounted. FIG. 8 illustrates a horizontal articulated robot, which is one type of the industrial robot, as an example.

The robot 100 includes arm joint portions 111 and a hand portion 112. Each arm joint portion 111 connects two arms 120 so that an angle at an intersection of the two arms 120 can be changed. The hand portion 112 includes an arm 120, a gripping portion 121 attached to one end of the arm 120, and a hand joint portion 122 that connects the arm 120 and the gripping portion 121.

The vibration-type actuator is built into each of the arm joint portion 111 and the gripping portion 121, and performs adjustment of the angles of the arms 120 and the hand joint portion 122 and a rotational operation of the arms 120 and the hand joint portion 122. A vibration-type actuator having T/N characteristics (drooping characteristics indicating a relationship between load torque and rotation speed) with low rotation speed and high torque is favorably used for a bending operation of the arm joint portion 111 and a gripping operation of the hand portion 112.

While the detailed description has been given of the present disclosure based on the exemplary embodiments, the present disclosure is not limited to these specific exemplary embodiments and includes various modes without departing from the gist of the present disclosure. For example, examples of an apparatus that can drive a contact body having a flat-plate shape in a freely selected direction within its plane can include an X-Y stage. The above-mentioned exemplary embodiments may be used alone or in combination.

According to the present disclosure, it is possible to provide a vibration-type actuator in which generation of undesired vibration is reduced and variations in vibration damping properties between lots are reduced. Additionally, according to the present disclosure, it is possible to provide an optical apparatus or an electronic apparatus including the vibration-type actuator in which generation of undesired vibration is reduced and variations in vibration damping properties between lots are reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-201981, filed Nov. 29, 2023, which is hereby incorporated by reference herein in its entirety.

What is claimed is:

1. A vibration-type actuator comprising:
a vibrating body including an electro-mechanical energy conversion element and an elastic body; and
a contact body configured to be in contact with the elastic body and extending in a first direction,
the vibration-type actuator being configured to cause the vibrating body to vibrate so as to cause the vibrating body and the contact body to relatively move in the first direction, the vibration-type actuator further comprising:
a vibration damping member extending in the first direction and configured to be in contact with a surface of the contact body on an opposite side of another surface of the contact body in contact with the vibrating body; and
a support member extending in the first direction and configured to support the contact body via the vibration damping member,
wherein the support member includes a convex portion on a surface of the support member in contact with the vibration damping member, the convex portion extending in the first direction and being in contact with the vibration damping member, and
wherein, in a direction orthogonal to the first direction, a width of the convex portion is smaller than a width of the contact body and smaller than a width of the vibration damping member.

2. The vibration-type actuator according to claim 1, wherein the vibration damping member includes a plurality of groove portions or a plurality of penetrating portions that is longer than the width of the convex portion in the direction orthogonal to the first direction.

3. A vibration-type actuator comprising:
a vibrating body including an electro-mechanical energy conversion element and an elastic body; and
a contact body configured to be in contact with the elastic body and extending in a first direction,
the vibration-type actuator being configured to cause the vibrating body to vibrate so as to cause the vibrating body and the contact body to relatively move in the first direction, the vibration-type actuator further comprising:
a vibration damping member extending in the first direction and configured to be in contact with a surface of the contact body on an opposite side of another surface of the contact body in contact with the vibrating body; and
a support member extending in the first direction and configured to support the contact body via the vibration damping member,
wherein the vibration damping member includes a plurality of groove portions or a plurality of penetrating portions that is longer than a width of the contact body in the direction orthogonal to the first direction.

4. The vibration-type actuator according to claim 3,
wherein the support member includes a convex portion on a surface of the support member in contact with the vibration damping member, the convex portion extending in the first direction and being in contact with the vibration damping member, and
wherein, in the direction orthogonal to the first direction, a width of the convex portion is smaller than the width of the contact body and smaller than a width of the vibration damping member.

5. The vibration-type actuator according to claim 3, wherein, in a case where the vibration damping member includes the plurality of groove portions, a bottom portion of each of the plurality of groove portions is not to be in contact with the contact body.

6. The vibration-type actuator according to claim 3, wherein the vibration damping member includes the plurality of groove portions or the plurality of penetrating portions at a position facing a node portion of out-of-plane bending vibration of the contact body, the out-of-plane bending vibration being generated by resonance of the contact body.

7. An optical apparatus comprising:
a vibration-type actuator that includes:
a vibrating body including an electro-mechanical energy conversion element and an elastic body; and
a contact body configured to be in contact with the elastic body and extending in a first direction, the vibration-type actuator being configured to cause the vibrating body to vibrate so as to cause the vibrating body and the contact body to relatively move in the first direction; and
at least one of an optical element or an image pickup element configured to be driven by the vibration-type actuator,
the vibration-type actuator further including:
a vibration damping member extending in the first direction and configured to be in contact with a surface of the contact body on an opposite side of another surface of the contact body in contact with the vibrating body; and
a support member extending in the first direction and configured to support the contact body via the vibration damping member,
wherein the support member includes a convex portion on a surface of the support member in contact with the vibration damping member, the convex portion extending in the first direction and being in contact with the vibration damping member, and
wherein, in a direction orthogonal to the first direction, a width of the convex portion is smaller than a width of the contact body and smaller than a width of the vibration damping member.

8. An electronic apparatus comprising a vibration-type actuator that includes:
a member;
a vibrating body including an electro-mechanical energy conversion element and an elastic body; and
a contact body configured to be in contact with the elastic body and extending in a first direction,
the vibration-type actuator being configured to cause the vibrating body to vibrate so as to cause the vibrating body and the contact body to relatively move in the first direction, the vibration-type actuator further including:
a vibration damping member extending in the first direction and configured to be in contact with a surface of the contact body on an opposite side of another surface of the contact body in contact with the vibrating body; and
a support member extending in the first direction and configured to support the contact body via the vibration damping member,
wherein the support member includes a convex portion on a surface of the support member in contact with the vibration damping member, the convex portion extending in the first direction and being in contact with the vibration damping member, and
wherein, in a direction orthogonal to the first direction, a width of the convex portion is smaller than a width of the contact body and smaller than a width of the vibration damping member.
